(19) United States
(12) Patent Application Publication
(10) Pub. No.: US 2019/0240760 A1
(43) Pub. Date: Aug. 8, 2019

(54) Display With Combined Weld and Engine Information

(71) Applicant: Lincoln Global, Inc., Santa Fe Springs, CA (US)

(72) Inventors: Edward A. Enyedy, Eastlake, OH (US); Patrick J. Donnelly, Lakewood, OH (US)

(21) Appl. No.: 15/891,792

(22) Filed: Feb. 8, 2018

(51) Int. Cl. B23K 9/095; B23K 9/32

(52) U.S. Cl. CPC B23K 9/0956; B23K 9/32

(57) ABSTRACT

The invention described herein generally pertains to a system and method for a welding device and, in particular, an engine-driven welding device that includes a display providing both welding power source data and engine data to a user. The display can provide welding power source data and engine data using multiple display states. For example, in one display state, the welding power source data and engine data can be displayed simultaneously. In another display state, only the welding power source data is displayed. In yet another display state, only engine data is displayed.

### TECHNICAL FIELD

The invention described herein pertains generally to a system and method for simultaneously displaying weld and engine information for an engine driven welder.

### BACKGROUND OF THE INVENTION

Frequently, welding can occur where line power may not be readily available. As such, a welder may be an engine driven welder incorporating a generator. The generator may supply power to the welder as well other power tools on site.

Traditional welding-type apparatus can be broken into two basic categories. The first category receives operational power from transmission power receptacles, also known as static power. The second is portable or self-sufficient, standalone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

Welding power source data such as operational parameters or notifications pertaining to the welding power source may be provided on a display dedicated to the welding power source. Similarly, engine data such as operational parameters or notifications pertaining to the engine are traditionally provided on a display dedicated to the engine.

### SUMMARY OF THE INVENTION

In accordance with the present innovation, there is provided a welding system that includes a welding power source configured to supply welding power for a welding operation, an engine coupled to the welding power source, wherein the engine supplies power to the welding power source, and a display configured to selectively switch between at least a first display state and a second display state based on a signal indicative of an active welding operation. The first display state displays welding power source data simultaneously with engine data and the second display state displays only welding power source data.

Also provided is method for displaying welding system data including receiving welding power source data pertaining to a welding power source configured to supply welding power for a welding operation, receiving engine data pertaining to an engine coupled to the welding power source, wherein the engine supplies power to the welding power source, displaying a first display state, wherein the first display state displays the welding power source data simultaneously with the engine data, receiving a signal indicative of an active welding operation, and displaying a second display state based on receiving the signal indicative of the active welding operation. The second display state displays only the welding power source data.

Also provided is a non-transitory, computer-readable storage medium having stored thereon computer-executable instruction for operating a display, wherein the instructions, when executed, configure a processor to obtain welding power source data from a welding power source configured to supply welding power for a welding operation, obtain engine data from an engine coupled to the welding power source, wherein the engine supplies power to the welding power source, display a first display state on a display, wherein the first display state displays the welding power source data simultaneously with the engine data, and selectively switch the display between at least the first display state and a second display state based on a signal indicative of an active welding operation. The second display state displays only the welding power source data.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a welding device that includes a motor as a power source;

FIG. 2 is a welding device;

FIG. 3 is a welding device affixed to a trailer for mobility;

FIG. 4 is a diagram illustrating an engine driven welding system;

FIG. 5 is a diagram illustrating a system for providing a combined display including engine and welder information;

FIG. 6 illustrates an exemplary display;

FIG. 7 illustrates a screen shot in accordance with an embodiment of the subject innovation;

FIG. 8 illustrates a screen shot in accordance with an embodiment of the subject innovation;

FIG. 9 illustrates a screen shot in accordance with an embodiment of the subject innovation;

FIG. 10 is a flow chart of a method in accordance with an embodiment of the subject innovation; and

FIG. 11 is a flow chart of a method in accordance with an embodiment of the subject innovation.

### DETAILED DESCRIPTION OF THE INVENTION

Embodiments of the invention relate to methods and systems for a welding device and, in particular, an engine-driven welding device that includes a display providing both welding power source data and engine data to a user. The display can provide welding power source data and engine data using multiple display states. For example, in one display state, the welding power source data and engine data can be displayed simultaneously. In another display state, only the welding power source data is displayed. In yet another display state, only engine data is displayed.

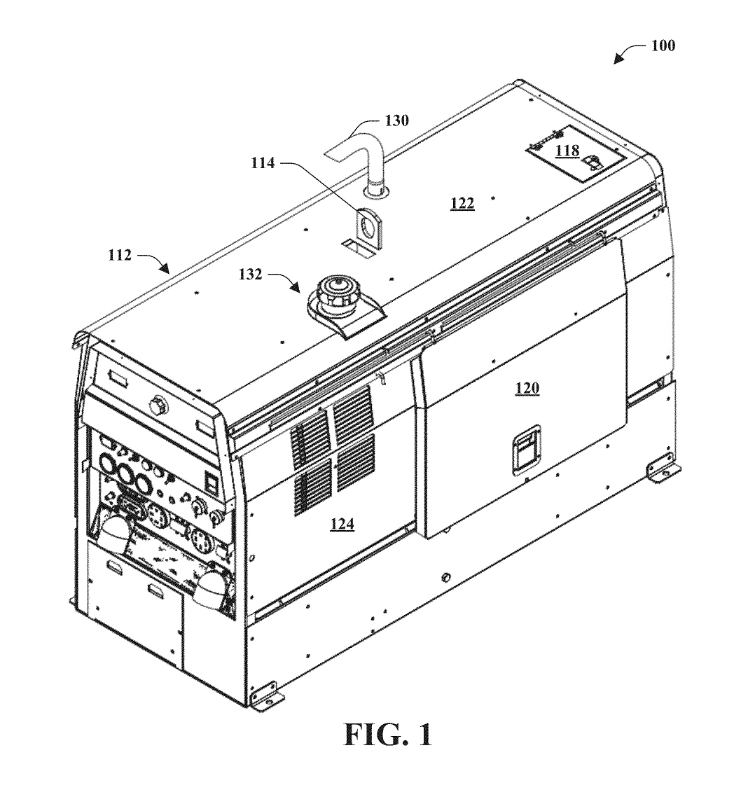

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or battery), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a rotor/stator assembly, a component that converts electrical power, or a combination thereof. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof.

“Welding” or “weld” as used herein including any other formatives of these words will refer to depositing of molten material through the operation of an electric arc including but not limited to submerged arc, GTAW, GMAW, MAG, MIG, TIG welding, any high energy heat source (e.g., a laser, an electron beam, among others), or any electric arc used with a welding system. Moreover, the welding operation can be on a workpiece that includes a coating such as, but not limited to, a galvanized coating.

“Component” or “Controller” as used herein can be a portion of hardware, a portion of software, or a combination thereof that can include or utilize at least a processor and a portion of memory, wherein the memory includes an instruction to execute.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed innovations. The embodiments and discussions herein can be readily incorporated into any of these systems and methodologies by those of skill in the art. By way of example and not limitation, a power supply as used herein (e.g., welding power source, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject innovation.

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. With reference to the drawings, like reference numerals designate identical or corresponding parts throughout the several views. However, the inclusion of like elements in different views does not mean a given embodiment necessarily includes such elements or that all embodiments of the innovation include such elements. The examples and figures are illustrative only and not meant to limit the innovation, which is measured by the scope and spirit of the claims.

FIG. 1 illustrates a welding device 100. The welding device 100 includes a housing 112 which encloses the internal components of the welding device. Optionally, the welding type device 100 includes a loading eyehook 114 and/or fork recesses 116. The loading eyehook 114 and the fork recesses 116 facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device (not shown) suitable for providing welding-type power. An end panel 126 includes a louvered opening 128 to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100. The internal combustion engine can operate on any known fuel including but not limited to gasoline, diesel, ethanol, natural gas, hydrogen, and the like. These examples are not limiting as other motors or fuels may be used.

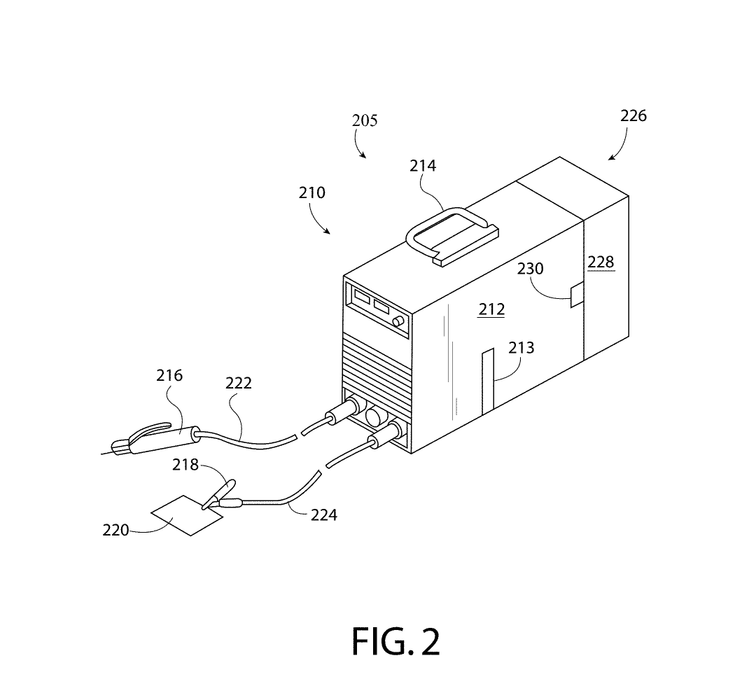

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

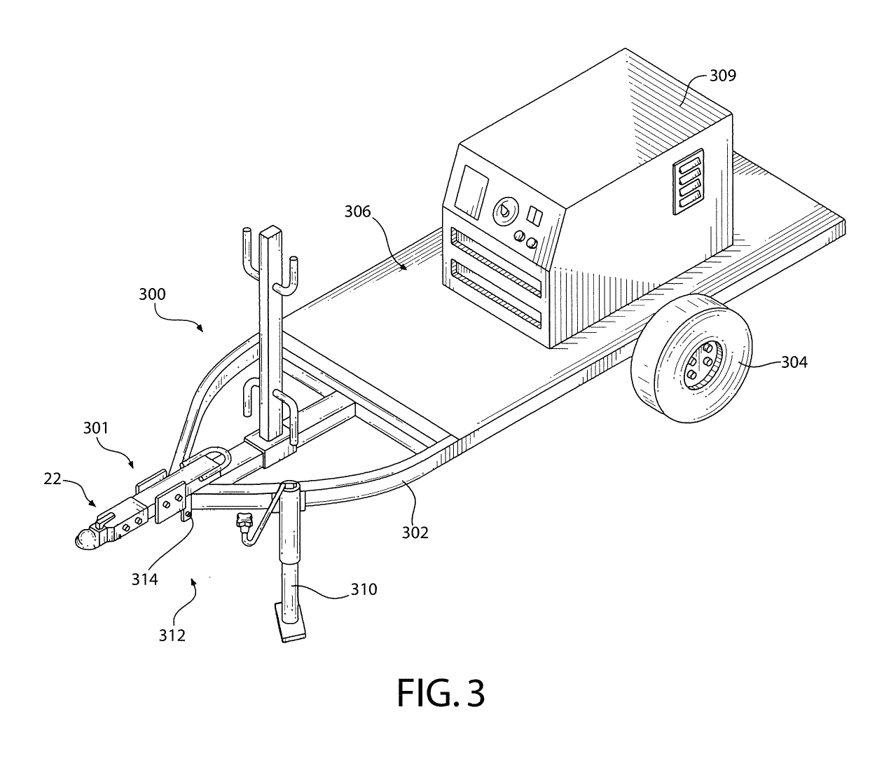

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

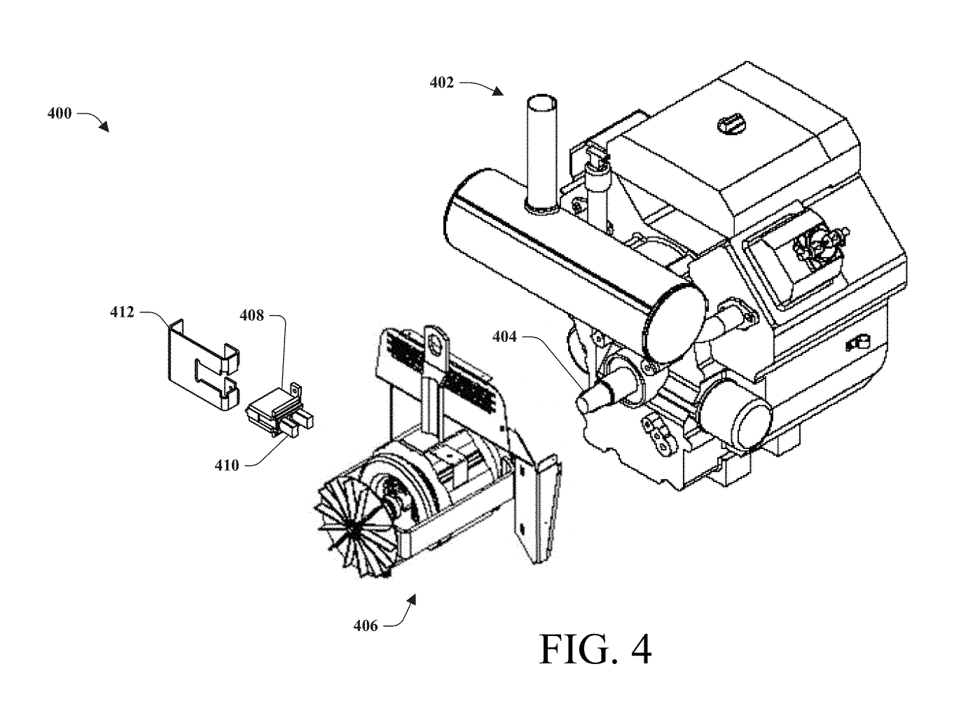

FIG. 4 illustrates engine driven welding system 400 that includes engine 402 that actuates shaft 404. In particular, engine 402 provides rotational movement to shaft 404 that is coupled to rotor/stator assembly 406. Rotor/stator assembly 406 includes a rotor that is coupled to shaft 404 for rotational movement and a stator that is stationary. It is to be appreciated that rotor/stator assembly 406 can be chosen with sound engineering judgment without departing from the scope of the subject innovation. For instance, the rotor and the stator of rotor/stator assembly 406 can include one or more electromagnets, wherein the rotor rotates from rotation from shaft 404 and stator is stationary and houses the rotor.

Rotor/stator assembly 406 can include at least one brush 410 that is housed in brush assembly 408 and affixed to a portion of rotor/stator assembly 406 via bracket 412. It is to be appreciated that brush assembly 408 can include at least one of a spring, a clip, a retainer, among others. Brush assembly 408 and bracket 412 can be chosen with sound engineering judgment without departing from the scope of the subject innovation. By way of example, brush assembly 408 is illustrated with a first brush and a second brush, however, it is to be appreciated that any suitable number of brushes can be used with the subject innovation. Brush 410 is in physical contact with at least a portion of rotor/stator assembly 406, wherein bracket 412 places brush 410 within proximity of rotor/stator assembly 406 and a spring (not shown) provides a force to brush 410 to physically contact rotor/stator assembly 406. In particular, brush 410 can physically contact a commutator (not shown) that is coupled to an axle (not shown) of the rotor included with rotor/stator assembly 406.

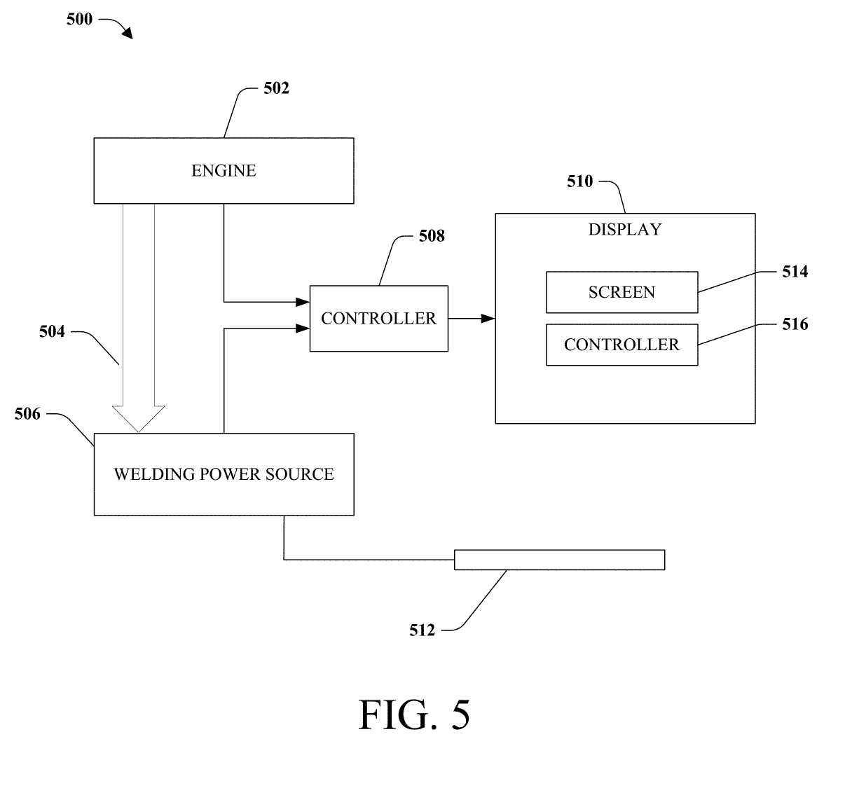

FIG. 5 illustrates a schematic block diagram of a welding system 500, and in particular, a welding system 500 that comprises an engine driven welding device as discussed in FIGS. 1-4. The welding system 500 can include an engine 502 configured to provide electrical power 504 to a welding power source 506. The welding system 500 can further include a controller 508 that can be configured to receive data from the engine 502 and/or the welding power source 506. The controller 508 can also be configured to communicate at least a portion of the data to a display 510, which can display both the engine data and the welding power source data simultaneously.

The engine 502 and the welding power source 506 can operate as discussed with regards to FIGS. 1-4. For example, the engine 502 can operate on gasoline or any other type of fuel. The engine 502 provides electrical power 504 to the welding power source 506 such that the welding power source 506 can condition the electrical power 504 and output welding power to a welding torch 512 to perform a welding operation. The engine 502 can include a monitoring component and diagnostics component. The monitoring component can monitor various operational or performance values of engine 502 using various sensors. For example, the monitoring component can include temperature sensors, level sensors, pressure sensors, current sensors, or voltage sensors. The diagnostics component can detect when an aspect of the engine 502 needs attention from the user. The monitoring component can monitor data such as, but not limited to, oil level, oil pressure, battery voltage, fuel level, engine temperature, coolant temperature, air filter status, spark plug life, diagnostic error codes, among others. The engine 502 can be configured to output the values, notifications, and alarms to another device such as the controller 508 or the display 510. The engine 502 can output the values, notifications, and alarms in the form of direct outputs such as an analog or digital signal, or by way of a digital communications protocol such as Ethernet or CAN communications, among others.

Similarly, the welding power source 506 can include a monitoring component and diagnostics component. The monitoring component can include, for example, temperature sensors, level sensors, pressure sensors, current sensors, or voltage sensors. The welding power source's 506 monitoring component can monitor values for welding power source data including, but not limited to, voltage settings, current settings, operating voltage, operating current, welding trigger signal, arc detection, output on/off, wire type, wire size, among others. The welding power source 506 can be configured to output the values, notifications, and alarms to another device such as the controller 508 or the display 510. The welding power source 506 can output the values, notifications, and alarms in the form of direct outputs such as an analog or digital signal, or by way of a digital communications protocol such as Ethernet or CAN communications, among others.

The controller 508 can receive inputs from both the engine 502 and the welding power source 506. In certain embodiments, the controller 508 can also control the operation of one of, or both of the engine 502 and welding power source 506. The controller's 508 communication with the engine 502 and the welding power source 506 can be in the form of direct inputs such as analog or digital signals, or by way of a digital communications protocol, such as Ethernet or CAN communications, over a bus or communications network. The controller 508 can process the data received from the engine 502 and the welding power source 506. For example, the controller 508 can scale direct input values to operational values defined by a user and can compare the received data to limits or thresholds to create alarms or notifications. The limits or thresholds can also be defined by a user. The controller 508 is in communication with the display 510 to output engine data and welding power source data to the display 510. The controller's 508 communication with the display can be in the form of a digital communication protocol such as CAN communications or Ethernet, among others, or it can be in the form of direct inputs such as analog or digital signals. The controller 508 can be configured to control the display 510 such that the display 510 can output information according to multiple display states, which are described in greater detail below.

The display 510 can receive the engine data and the welding power source data from the controller 508. The display 510 can include a screen 514. The screen 514 can be any type of display screen including, but not limited to, liquid crystal display (LCD), thin-film-transistor LCD (TFT LCD), light emitting diodes, plasma screen, among others. The display 510 can have various display screens stored thereon in computer readable memory for visually presenting the engine data and the welding power source data to a user in various display states. The display 510 can present the display screens on the screen 514 with various data fields populated by the engine data and/or the welding power source data. The display 510 can also present various display screens that allow a user to configure settings or specify parameters associated with the engine 502 or the welding power source 506. Additional display screens can include tutorial screens that provide a user with instructions related to the welding process, or service screens that can include both engine data and welding power source data pertaining to service needs of the engine 502 or welding power source 506, or service interval information such as estimated time until service is needed for the engine 502 or the welding power source 506. It should be appreciated that the display 510 can also receive and display information about an air compressor, a hydraulic pump, or auxiliary power.

The display 510 can further include a display controller 516. In certain embodiments, the display controller 516 can perform some, or all of the functions of the controller 508. For example, the display 510 can receive the engine data and the welding power source data directly from the engine 502 and welding power source 506. In these embodiments, the display controller 516 can scale the inputs and control the display 510 such that the display 510 can operate in multiple display states.

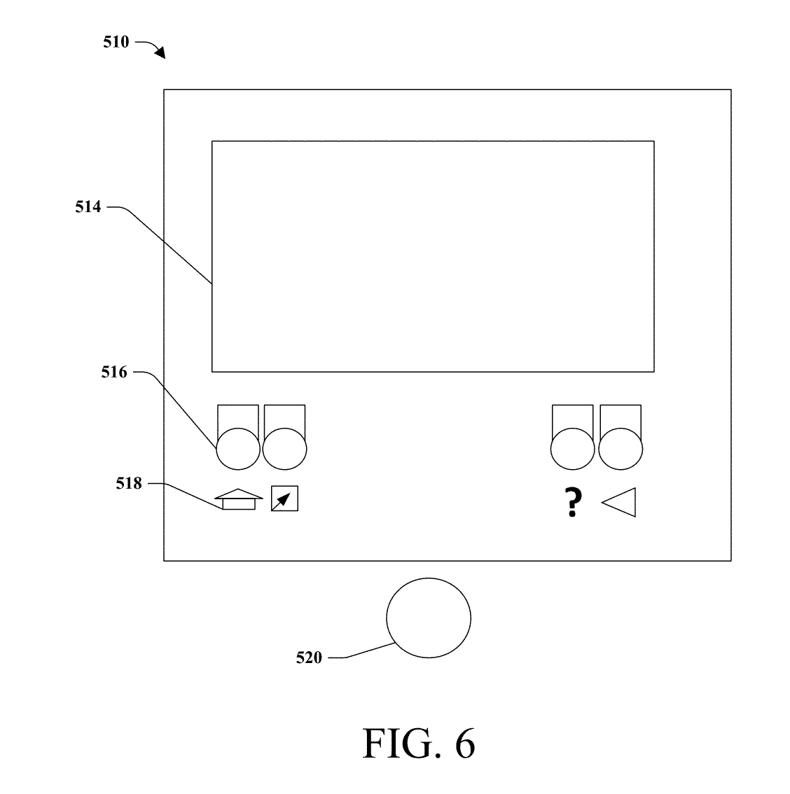

Turning now to FIG. 6, an exemplary display 510 is shown. Below the screen 514, the display 510 includes pushbuttons 516 that allow a user to interact with the display 510. Below each button, an icon 518 indicates each pushbutton's 516 function. For example, the display 510 can include pushbuttons for navigating to a home display screen, selecting an item on a display screen, opening a help or tutorial display screen, or navigating backwards to a previous display screen. Optionally, the display 510 can further include a knob 520. The knob 520 can allow the user to navigate among a display screen by twisting the knob 520, or select an item on a display screen by pressing the knob 520. In certain embodiments, the screen 514 can have touchscreen functionality to allow a user to make selections via direct interactions with the screen 514.

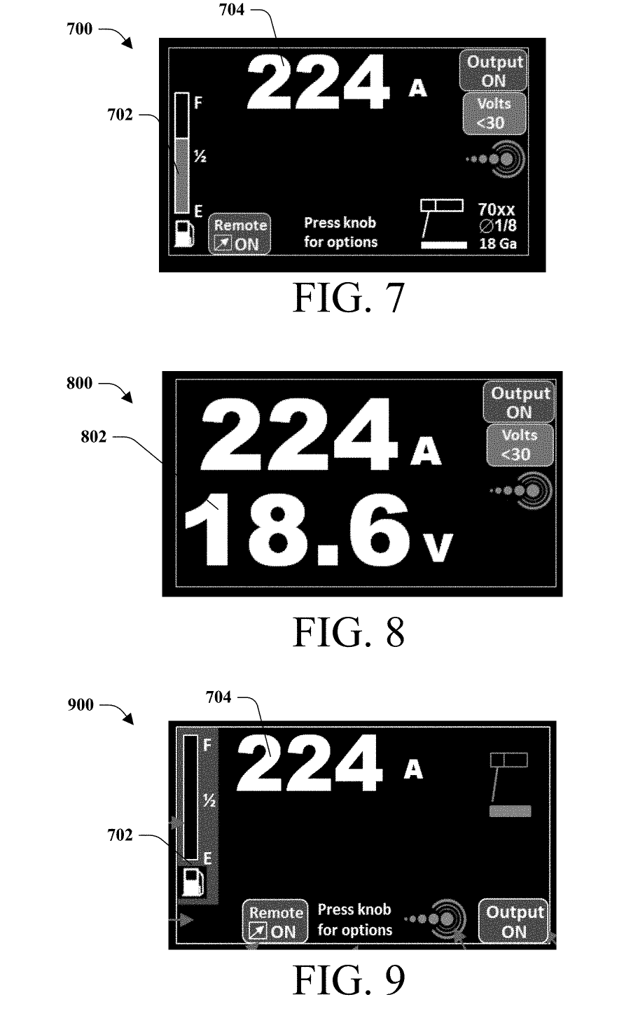

Turning now to FIGS. 7-9, various display screens are depicted, each presented as part of different display states. Display screen 700 is presented as part of a first display state. During the first display state, engine data is displayed simultaneously with welding power source data. The data presented can be in the form of numerical values, text notifications, gauges, picture indications, alarm displays, notification displays, among others. In one example, the display 510 can operate in the first display state when the welding system 500 is idle. On display screen 700, engine data 702 such as a fuel level gauge is displayed. In addition to the engine data, welding power source data 704 is displayed simultaneously.

While a user conducts a welding operation with the welding system 500, the display 510 can operate in a second display state. For example, display screen 800 is presented as part of a second display state. During the second display state, the engine data 702 is removed from the screen 514, and only the welding power source data 704 is displayed. In other embodiments, during the second display state, the engine data 702 is maintained on the screen 514, but at a decreased size to make more room on the screen 514 for welding power source data 704. In certain embodiments, the welding power source data 704 can be displayed at a larger font size or a different color than during the first display state. This larger font size or different color can allow a user to see the relevant welding power source data 704 easier while conducting the welding operation. The display 510 can switch from the first display state to the second display state based on a signal indicative of an active welding operation. The signal indicative of an active welding operation can be based on at least one of a trigger signal from a welding torch, a detection of an arc, or a detection of welding current. In certain embodiments, the controller 508 receives the signal indicative of an active welding operation and communicates a display transition command to the display 510 to command the display 510 to switch display states. In other embodiments, the signal indicative of an active welding operation can be received directly at the display 510 or display controller 516 to initiate a display state transition.

The display 510 can operate in a third display state when an error or fault condition related to the welding system 500 is present. The error or fault condition can include, for example, a notification or alarm alerting the user that a value is outside of a threshold, or that a component of the welding system 500 needs attention or servicing. For example, display screen 900 is presented as part of a third display state. During the third display state, engine data 702 is displayed simultaneously with welding power source data 704. However, the engine data 702 (e.g. the fuel level gauge on display screen 900), is displayed as a different color than during the first display state. In one example, a fuel level gauge can be displayed on display screen 700 with a green bar in a gauge having a black background. If the fuel level is depleted below a predetermined threshold, the fuel level gauge reappears on display screen 900 with a yellow bar in a gauge having a red background. In certain embodiments, the gauge's background can flash. In certain embodiments, the display 510 can emit an audible tone during the third display state to alert a user to the error condition. As soon as the error condition or conditions that cause the display 510 to operate in the third display state are rectified, the display 510 can return back to operating in the first display state if the welding system 500 is idle, or the second display state if the welding system 500 is active.

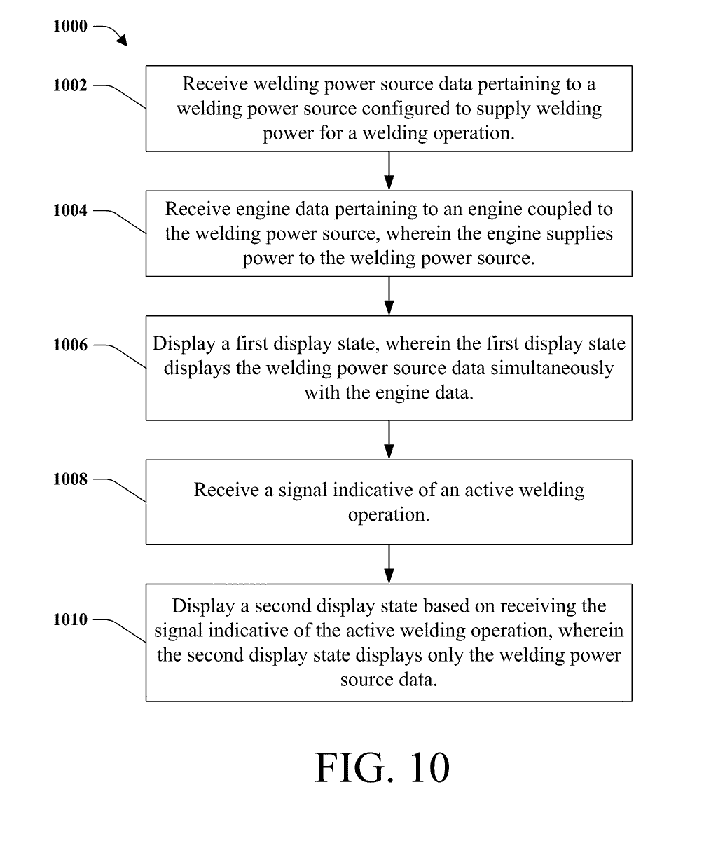

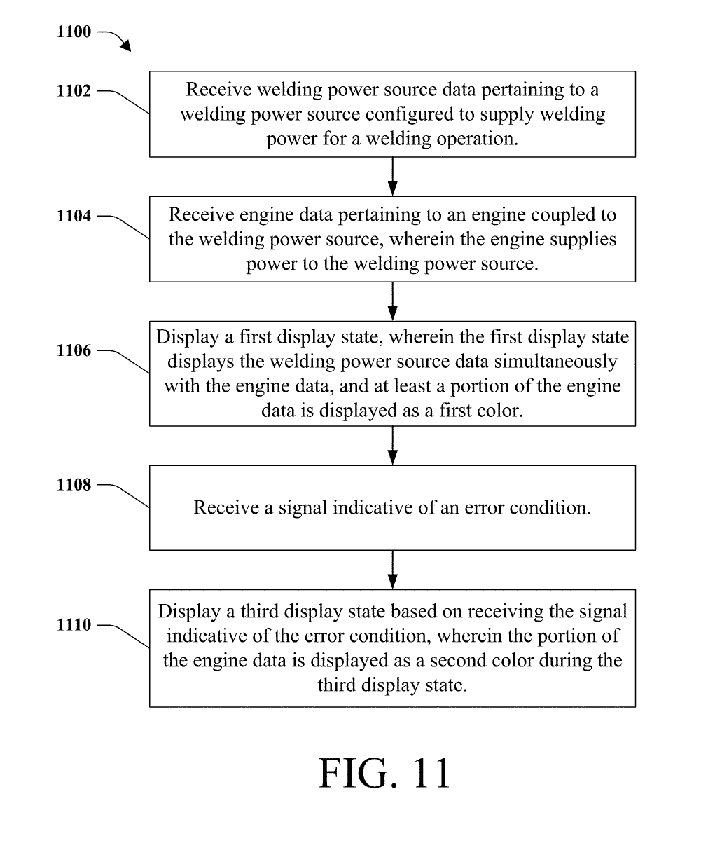

FIGS. 10 and 11 illustrate exemplary methods 1000 and 1100 that can be implemented by an engine driven welding device, such as welding system 500, as described in FIGS. 1-5. It should be appreciated that methods 1000 and 1100 can be performed by controller 508, display 510, display controller 516, or any combination of these components. Turning first to FIG. 10, at reference numeral 1002, welding power source data is received. The welding power source data pertains to a welding power source configured to supply welding power for a welding operation. At reference numeral 1004, engine data is received. The engine data pertains to an engine coupled to the welding power source, wherein the engine supplies power to the welding power source (e.g., via a generator). At reference numeral 1006, a first display state is displayed, wherein the first display state displays the welding power source data simultaneously with the engine data. At reference numeral 1008, a signal indicative of an active welding operation is received. At reference numeral 1010, a second display state is displayed based on receiving the signal indicative of the active welding operation, wherein the second display state displays only the welding power source data.

Turning now to FIG. 11, at reference numeral 1102, welding power source data is received. The welding power source data pertains to a welding power source configured to supply welding power for a welding operation. At reference numeral 1104, engine data is received. The engine data pertains to an engine coupled to the welding power source, wherein the engine supplies power to the welding power source. At reference numeral 1106, a first display state is displayed, wherein the first display state displays the welding power source simultaneously with the engine data, and at least a portion of the engine data is displayed as a first color. At reference numeral 1108, a signal indicative of an error condition is received. At reference numeral 1110, a third display state is displayed based on receiving the signal indicative of the error condition, wherein the portion of the engine data is displayed as a second color during the third display state.

Disclosed is an embodiment of a welding system that includes a welding power source configured to supply welding power for a welding operation, an engine coupled to the welding power source, wherein the engine supplies power to the welding power source, and a display configured to selectively switch between at least a first display state and a second display state based on a signal indicative of an active welding operation. The first display state displays welding power source data simultaneously with engine data and the second display state displays only welding power source data.

In this embodiment, the display can be configured to operate in the first display state when the welding operation is not being performed, and in the second display state when the welding operation is being performed. The welding power source data can be displayed at a first font size during the first display state, and at a second font size during the second display state. The signal indicative of an active welding operation can be based on at least one of a trigger signal from a welding torch, a detection of an arc, or a detection of welding current. Also in this embodiment, the welding system can further comprise a controller configured to receive the welding power source data and the engine data and transmit the welding power source data and the engine data to the display. The display can comprise a display controller configured to switch the display between the first display and the second display based on the signal indicative of an active welding operation. The display can be further configured to selectively switch between the first display state and a third display state based on a signal indicative of an error condition pertaining to the welding system. The display can be configured to operate in the first display state when the error condition is not present, and in the third display state when the error condition is present and at least a portion of the engine data can be displayed as a first color during the first display state, and as a second color during the third display state.

Also disclosed is an embodiment of a method for displaying welding system data including receiving welding power source data pertaining to a welding power source configured to supply welding power for a welding operation, receiving engine data pertaining to an engine coupled to the welding power source, wherein the engine supplies power to the welding power source, displaying a first display state, wherein the first display state displays the welding power source data simultaneously with the engine data, receiving a signal indicative of an active welding operation, and displaying a second display state based on receiving the signal indicative of the active welding operation. The second display state displays only the welding power source data.

Also disclosed is an embodiment of a non-transitory, computer-readable storage medium having stored thereon computer-executable instruction for operating a display, wherein the instructions, when executed, configure a processor to obtain welding power source data from a welding power source configured to supply welding power for a welding operation, obtain engine data from an engine coupled to the welding power source, wherein the engine supplies power to the welding power source, display a first display state on a display, wherein the first display state displays the welding power source data simultaneously with the engine data, and selectively switch the display between at least the first display state and a second display state based on a signal indicative of an active welding operation. The second display state displays only the welding power source data.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed innovations. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject innovation.

The above examples are merely illustrative of several possible embodiments of various aspects of the present innovation, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the innovation. In addition although a particular feature of the innovation may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the innovation, including the best mode, and also to enable one of ordinary skill in the art to practice the innovation, including making and using any devices or systems and performing any incorporated methods. The patentable scope of the innovation is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the innovation has been described for purposes of illustrating the best mode known to the applicant at the time and enable one of ordinary skill in the art to practice the innovation, including making and using devices or systems and performing incorporated methods. The examples are illustrative only and not meant to limit the innovation, as measured by the scope and merit of the claims. The innovation has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the innovation is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A welding system comprising:
a welding power source configured to supply welding power for a welding operation;
an engine coupled to the welding power source, wherein the engine supplies power to the welding power source; and
a display configured to selectively switch between at least a first display state and a second display state based on a signal indicative of an active welding operation, wherein the first display state displays welding power source data simultaneously with engine data and the second display state displays only welding power source data.

2. The welding system of claim 1, wherein the display is configured to operate in the first display state when the welding operation is not being performed, and in the second display state when the welding operation is being performed.

3. The welding system of claim 1, wherein the welding power source data is displayed at a first font size during the first display state, and at a second font size during the second display state.

4. The welding system of claim 1, wherein the signal indicative of an active welding operation is based on at least one of a trigger signal from a welding torch, a detection of an arc, or a detection of welding current.

5. The welding system of claim 1, further comprising a controller configured to receive the welding power source data and the engine data and transmit the welding power source data and the engine data to the display.

6. The welding system of claim 1, wherein the display comprises a display controller configured to switch the display between the first display and the second display based on the signal indicative of an active welding operation.

7. The welding system of claim 1, wherein the display is further configured to selectively switch between the first display state and a third display state based on a signal indicative of an error condition pertaining to the welding system.

8. The welding system of claim 7, wherein the display is configured to operate in the first display state when the error condition is not present, and in the third display state when the error condition is present.

9. The welding system of claim 7, wherein at least a portion of the engine data is displayed as a first color during the first display state, and as a second color during the third display state.

10. A method for displaying welding system data, comprising:
receiving welding power source data pertaining to a welding power source configured to supply welding power for a welding operation;
receiving engine data pertaining to an engine coupled to the welding power source, wherein the engine supplies power to the welding power source;
displaying a first display state, wherein the first display state displays the welding power source data simultaneously with the engine data;
receiving a signal indicative of an active welding operation; and
displaying a second display state based on receiving the signal indicative of the active welding operation, wherein the second display state displays only the welding power source data.

11. The method of claim 10, wherein the welding power source data is displayed at a first font size during the first display state, and at a second font size during the second display state.

12. The method of claim 10, wherein the signal indicative of the active welding operation is a trigger signal from a welding torch.

13. The method of claim 10, wherein the signal indicative of the active welding operation is based on at least one of a trigger signal from a welding torch, a detection of an arc, or a detection of welding current.

14. The method of claim 10, further comprising:
receiving a signal indicative of an error condition; and
displaying a third display state based on receiving the signal indicative of an error condition, wherein at least a portion of the engine data is displayed as a first color during the first display state, and as a second color during the third display state.

15. A non-transitory, computer-readable storage medium having stored thereon computer-executable instruction for operating a display, wherein the instructions, when executed, configure a processor to:
obtain welding power source data from a welding power source configured to supply welding power for a welding operation;
obtain engine data from an engine coupled to the welding power source, wherein the engine supplies power to the welding power source;
display a first display state on a display, wherein the first display state displays the welding power source data simultaneously with the engine data; and
selectively switch the display between at least the first display state and a second display state based on a signal indicative of an active welding operation, wherein the second display state displays only the welding power source data.

16. The non-transitory, computer-readable storage medium of claim 15, further storing instructions that configure the processor to display the first display state when the welding operation is not being performed, and display the second display state when the welding operation is being performed.

17. The non-transitory, computer-readable storage medium of claim 15, further storing instructions that configure the processor to display the welding power source data at a first font size during the first display state, and at a second font size during the second display state.

18. The non-transitory, computer-readable storage medium of claim 15, further storing instructions that configure the processor to selectively switch the display between the first display state and a third display state based on a signal indicative of an error condition.

19. The non-transitory, computer-readable storage medium of claim 15, further storing instructions that configure the processor to display the first display state when the error condition is not present, and to display the third display state when the error condition is present.

20. The non-transitory, computer-readable storage medium of claim 15, further storing instructions that configure the processor to display at least a portion of the engine data as a first color during the first display state, and as a second color during the third display state.
